(19) United States
(12) Patent Application Publication
(10) Pub. No.: US 2013/0156127 A1
(43) Pub. Date: Jun. 20, 2013

(54) OFDM Synchronization and Signal Channel Estimation

(71) Applicant: Donald L. Schilling, Palm Beach Gardens, FL (US)

(72) Inventor: Donald L. Schilling, Palm Beach Gardens, FL (US)

(21) Appl. No.: 13/473,190

(22) Filed: May 16, 2012

Related U.S. Application Data
(63) Continuation-in-part of application No. 12/831,345, filed on Jul. 7, 2010, now abandoned.

(51) Int. Cl. H04L 25/02

(52) U.S. Cl. CPC H04L 25/02
USPC 375/295

(57) ABSTRACT

Synchronization and signal channel estimation is accomplished by adding pilot signals to the outputs of IFFT encoders, i.e. after encoding of data/symbols, in a spread spectrum wireless communication system utilizing uniquely designed OFDM transmitters, OFDM receivers and OFDM systems and methods.

### CROSS-REFERENCE TO RELATED PATENT APPLICATION

This application is a continuation-in-part of pending U.S. patent application Ser. No. 12/831,345 filed Jul. 7, 2010, the entire disclosure of which is incorporated herein by reference.

### BACKGROUND OF THE INVENTION

1. Field of the Invention

The present invention relates to spread spectrum wireless communication and, more particularly, to methods, systems, transmitters and receivers for spread spectrum communication over a fading, multipath channel with improved synchronization and signal channel estimation.

2. Brief Discussion of the Related Art

OFDM is a spread spectrum communications technique, often used to communicate in wireless fading, multipath channels and typically incorporate pilot signals which, as used herein, include pilot tones (frequency components) or pilot codes, as well as other transmitted signals providing information identifying a source of transmitted data and/or estimating channel parameters. In order to synchronize incoming signals to a locally generated synchronizing signal and in order to estimate channel parameters which vary with time, some timing information must be sent along with the transmitted data. Some prior art sends known “training” signals at the start of each burst of transmitted data. Other prior art sends “pilot” signals in several of the data channels. Other prior art employs both training and pilot signals. Problems become severe in mobile environments since channel changes depend, in part, on the motion of a remote user.

OFDM/MIMO modulators typically demultiplex an encoded, interleaved, data stream of rate f_{B}, to divide it into N parallel data, spatial, streams, each of rate f_{D}=f_{B}/N where f_{D} is the data rate after demultiplexing, f_{B} is the incoming data rate prior to demultiplexing and N is the number of parallel, data, spatial streams. The data is typically FEC encoded and interleaved, and then mapped into a complex symbol (QAM), either prior to the demultiplexer, or after demultiplexing in each of the demultiplexed streams. For simplicity, the FEC encoder, interleaver and mapper are not described in detail herein. The N data streams are each spread, every T sec, by an IFFT encoder (the spreading function) to the bandwidth, B, of the available transmitting channel. 1/T is the IFFT sampling rate. Thus, the spreading achieved by the IFFT is equal to BT.

As is well known, each IFFT has K complex inputs, and these K, IFFT inputs form an OFDM symbol every T seconds where each OFDM symbol is formed of K, complex data numbers resulting in an output of the IFFT having K complex output numbers. These complex output numbers are each sampled in sequence during a time T, by a device which performs the function of a parallel-to-serial converter. The K output numbers being sampled at the rate 1/T sec, defines the IFFT output waveform (actually the output of the parallel-to-serial converter) of bandwidth, B, where K=BT. This time-domain output waveform is therefore formed of a sum of K, QAM waveforms, each centered at a subchannel frequency fₖ=kB/K.

In summary, the FEC coded, complex-mapped data is collected every T sec to form an OFDM symbol. The OFDM symbol is inputted to an IFFT and transformed into K complex output numbers every T seconds. Using a parallel-to-serial converter (or equivalent device) the K numbers are scanned sequentially, each T seconds, to form a time-domain output waveform. Since this Fourier Transform process is repeated each T seconds, the output waveform consists of a sum of K sub-channel waveforms, each centered at a sub-channel frequency, fₖ=kB/K. Since the IFFT OFDM symbol rate is equal to 1/T OFDM symbols/sec and the output bandwidth of the IFFT spreading function is B, the input OFDM symbol has been spread in bandwidth by a “spreading factor”=BT=K.

A typical prior art OFDM spread spectrum communication system is shown in FIGS. 1 and 2, an OFDM/MIMO prior art transmitter being shown in FIG. 1 and a prior art OFDM/MIMO receiver being shown in FIG. 2. The prior art OFDM/MIMO transmitter shown in FIG. 1 includes a data input 30 supplied to a coding and interleaving circuit 32 which supplies the coded and interleaved data at a data rate f_{B} to a demultiplexer 34 for demultiplexing the coded and interleaved data into a number, N, of spatial streams denoted by numbers CH1 . . . CHN with only streams CH1 and CHN shown in FIG. 1 and the understanding that each stream has the same arrangement of circuits. It is common to omit the FEC and interleaver prior to the demultiplexer. It is common to FEC code and interleave and then modulate each of these data streams using QAM modulation. The use of FEC coding and interleaving and/or QAM modulation is not discussed in detail in the present application for simplicity purposes. The demultiplexed, coded and interleaved data in each spatial stream is supplied at a data rate f_{D}(=f_{B}/N) to a serial-to-parallel S/P converter, or mapper, along with pilot signals and other overhead signals, and the outputs of the SIP converter, form the OFDM symbol, which is supplied to a K-point spreading encoder such as an IFFT encoder along with the pilot signals and a signal from a clock 35. The IFFT spreader generates a time-domain waveform having K samples shown as 1, 2 . . . , K, for the coded and interleaved data, the pilot and training signals, and any other signals to be sent. The IFFT input is an OFDM symbol, composed of K complex numbers. The K complex numbers arrive at the data rate supplied to the S/P which is f_{D}. Thus, an IFFT input symbol is formed every T(=K/f_{D}). In practice T is fixed, so that the data rate f_{D} must be a constant. Note that the input OFDM symbol changes at the fixed rate, 1/T and, hence, requires an effective input bandwidth of 1/T=f_{D}/K. Hence, each of the K subchannels will have a bandwidth of approximately (taking into account other signals sent) f_{D}/K. Thus, the output of the IFFT spreader changes once every T(=K/f_{D}) seconds. Similarly, the pilot/training signals are generated once every K/f_{D} seconds, such that modulation of the pilot/training signals changes at a slow rate, i.e. at the subchannel rate. The IFFT has K complex output terminals and transforms the input OFDM symbol, having an input symbol rate equal to 1 OFDM symbol every T seconds, into an output waveform with a bandwidth, B, where B=K/T using the parallel-to-serial converter at the IFFT output. The spreading produced by the IFFT is equal to the output bandwidth B, divided by the OFDM symbol rate, 1/T. Thus the IFFT spreads the spectrum by spreading=K.

The output from each parallel-to-serial converter P/S which follows its IFFT is inputted to a transmit antenna TA1 . . . TAN.

A typical prior art OFDM/MIMO spread spectrum receiver is shown in FIG. 2 and includes a plurality of receiver antennas denoted as RA1 . . . RAN, it being noted that the designation N has been used for simplicity purposes, since the number of receiver antennas could be greater than or equal to the number of transmit antennas. In order for the OFDM/MIMO receiver to undo the transmitting operations provided by the OFDM/MIMO transmitter of FIG. 1, each receiver antenna receives all of the received transmitted signals including the respective multipath signals that reach the antenna. These signals have traveled over different channels and, therefore, are characterized by different channel transfer functions. Further, each of the N transmitted signals consist of the sum of K orthogonal signals, one for each of the orthogonal subcarriers. Thus, the sum of NK waveforms plus an unlimited number of multipath waveforms can appear at each of the N receiver antennas. Each receiver system, of each receive antenna, samples the received composite waveform, every T/K seconds during the time T during which the signal is received. The K waveform sample values containing the sum of all received NK and multipath received signals are supplied to a respective serial-to-parallel converter S/P 1, . . . , N. Thus, each FFT can receive NK signals, with their multipath, and this sum is represented by K time-domain samples.

Each FFT spread spectrum decoder 1, N, undoes the IFFT spread spectrum encoding and, supplies K (subcarrier) outputs to a parallel-to-serial converter, P/S-1, . . . , P/S-N. The outputs of each converter P/S 1 . . . N are then supplied to a combiner/data processor 36 that performs channel estimation, signal separation, symbol recovery, and space diversity combining and time diversity combining (when desirable) and, finally, multiplexing of the N estimated spatial streams to provide an estimate of the transmitted data. The parallel-to-serial converters are not required, as all that is required is to input all FFT outputs to the combiner/data processor, for parallel processing.

Changes in the FFT outputs occur every T sec; and, only after the combiner/data processor, does the receiver produce an estimate of the original data, and the data rate reverts back to the original data rate, f_{B}=Nf_{D}. Accordingly, it should be appreciated that all operations in prior art OFDM/MIMO spread spectrum communication systems occur at the rate f_{D}/K=1/T, which defines the OFDM symbol duration, that is, the time required to load all input information into the K subchannels of the transmitter IFFTs.

The operations of the prior art transmitter of FIG. 1 and the prior art receiver of FIG. 2 are typically synchronized by a synch clock, and synchronizing information is transmitted in the training signals and/or in the pilot signals so that correction can occur every time, T.

The prior art transmitter injects the pilot codes at the input to the IFFT encoder, where it detracts from the true data rate. In addition, as will be seen below, the prior art initially transmits training signals in lieu of data to establish synchronization, again detracting from the total data transmitted/sec.

Ozdemir, M. K., in an article entitled, “Channel Estimation of Wireless OFDM Systems”, IEEE Communications Magazine, 2007, illustrates two techniques employed to estimate a multipath channel. The first technique is to send a known training sequence of symbols at the start of each packet. Using the known sequence, the channel can be estimated. In a multi-user system, where every user transmits to the base station, the base station provides each remote user with a temporary training sequence, so the base station can synchronize to each user. The second technique consists of sending an orthogonal sequence in several specified channels of each of the multi-channel OFDM spread spectrum signals such that each receiver is able to identify which antenna transmitted the signal. Thus, if the IFFT encoder processes 64 symbols simultaneously, there are 64 rows containing data symbols, training symbols, and pilot symbols. The training symbols have replaced data symbols and, as a result, cause a decrease in data rate. To minimize this effective reduction in data transmitted per unit of time per unit bandwidth, the number of training symbols is made as small as possible, typically 10%. However, if the channel changes, during the time between training symbol bursts, the calculated channel parameters will be in error.

Another technique is to continuously send a pilot signal in several of the multichannels used in the transmitter. The sending of several pilot signals, rather than a single pilot signal, is required since the channel is a multipath fading channel. The fading is frequency sensitive and can extend over several of the subchannels. Fades of 5 MHz are typical in many environments. The number of pilot signals, usually 4, 6, or 8, depending on the overall bandwidth, is chosen to yield pilot signals which fade in an uncorrelated manner with one another. The pilot signals may be coded across frequency as well as time and provide synchronization as well as aid in channel estimation. In order to avoid a significant decrease in data rate, the pilot signal may be transmitted intermittently. The pilot signal changes at the IFFT encoder subchannel rate, I/T=f_{D}/K. Hence, variations in the channel occurring during the symbol time (T=K/f_{D}) are not detected. Additionally, variations of the channel occurring when no pilot or training sequence is occurring are not detected.

U.S. Pat. No. 7,145,940 to Gore et al, U.S. Pat. No. 7,457,376 to Sadowsky and U.S. Pat. No. 8,018,975 to Ma et al are representative of other prior art techniques that have various disadvantages. In the technique disclosed in Ma et al, pilot and training sequences are used for coarse and fine synchronization but are not sent during the time that the data is transmitted. Thus, changes in the channel during the time of data-only transmission are not detected. In the technique disclosed in Gore et al, the pilot is multiplexed with the data prior to the IFFT conversion to an OFDM spread spectrum signal. Thus, pilot signals are sent over several, presumably uncorrelated, subchannels while the data is sent over the other subchannels. That is, pilot signals and data are not sent over the same subchannel. Additionally, the bandwidth of each pilot signal is equal to the subchannel bandwidth which is I/T. Accordingly, synchronization and channel estimation are not acceptably provided in a rapidly fading channel environment. In Sadowsky, it is assumed that the channel can be perfectly measured. The input signal possibilities are compared to the possibilities that would be present in a line of sight, non-fading, no noise channel, and the one that is selected is the one that minimizes the mean square error. However, in a real life situation, the wireless channel does fade.

The IEEE Standard 802.16, intended for cellular type operation, includes 8 pilot subcarriers in each spatial stream. The subcarriers are each modulated using a different PN sequence. The sequences transmitted over the different antennas (the spatial streams) employ different, but orthogonal, periodic sequences. Since the time duration of each spatial stream from transmit to receive antennas differ, the spatial streams may not be orthogonal at reception. While the separation of pilots are an attempt to minimize the fading being correlated over many of the pilot subchannels, that need not be the case. Indeed, indoor, where there is a considerable amount of fading, the fading is often referred to as “flat fading,” and the received multipath, after the FFT receiver, may show that a large number of pilots can be effectively undetectable, resulting in poor channel estimation and poor frequency synchronization.

The IEEE Standard 802.11n illustrates the use of 4 pilots in a 20 MHz band and 6 pilots in a 40 MHz band. Different, orthogonal codes are used for each antenna. The codes change at the same rate as the data, that is, at the OFDM symbol rate, I/T. As in 802.16, the flat fading at each subchannel can result in one or more pilots being effectively undetectable.

### SUMMARY OF THE INVENTION

A primary aspect of the present invention is to improve frequency synchronization and signal channel estimation in an OFDM communication system by adding the pilot signals to the already encoded spread spectrum OFDM signals at a transmitter to produce transmit signals formed of pilot signals added to OFDM encoded signals for transmission to a receiver.

In a further aspect, the present invention employs as a pilot signal, a signal which is amplitude modulated using a direct sequence chip code having a bandwidth covering the entire available frequency band and which is added to the output of each encoder (e.g. IFFT, multichannel orthogonal modulation system, or the like) of an OFDM transmitter such that the pilot signal is not encoded (e.g. by the IFFT). As a result, the pilot signal has a rate which is significantly higher than in the prior art where pilot signals change at the IFFT (OFDM) symbol rate.

In another aspect, the present invention relates to transmitters, receivers, methods and systems for OFDM wireless communications where pilot signals for synchronization and signal channel estimation are added to data signals after OFDM encoding thereof to produce a combined spread spectrum signal for transmission with a number of subchannels carrying data and at least one subchannel carrying the pilot signals.

In an additional aspect, the present invention relates to an OFDM (spread spectrum) system, which can be MIMO, where, at a transmitter, pilot signals are added to OFDM encoded data signals after OFDM encoding; and, at a receiver, the pilot signals are split from the received signals for detection in a path parallel to decoding of the OFDM encoded data signals.

In another aspect of the present invention, a transmitter generates pilot signals to be added to OFDM encoded signals after encoding where the pilot signals each have a different chip code and the same code length and the chip rate divided by the code length is greater than or equal to the subchannel bandwidth of the encoder.

In a further aspect of the present invention, an OFDM receiver includes antennas receiving transmitted OFDM encoded signals with added pilot signals, pilot detector means detecting the pilot signals and synchronizing and determining channel parameters, a signal detector for estimating the data received at each antenna, a combiner for combining data received at each antenna and a multiplexer to multiplex the data received into a single data stream.

Some of the advantages of the present invention over the prior art include providing a significantly higher data rate, improvement of synchronization in an OFDM communications system by as much as a factor of K where K is the number of subchannels in each IFFT, improvement of channel estimation in an OFDM communication system due to estimating channel parameters up to K times during each transmitted symbol (sampling interval) as opposed to estimating channel parameters once per transmitted symbol as is prescribed in the IEEE Standards 802.11 and 802.16 referenced above, and the method of transmitting synchronization information differs from the prior art to allow correction to occur every T/K seconds by using a wideband direct sequence spread spectrum technique to generate the pilot signals. If the data rate to the IFFT encoder is f_{D} and there are K subchannels, there are f_{D}/K encoded symbols transmitted per/sec in each subchannel, and the spread spectrum system chip code is transmitted at the rate f_{D} which is equal to f_{D} such that there are K chips transmitted/IFFT input symbol as compared to prior art systems where pilot code changes are at the IFFT (OFDM) subchannel rate, I/T. Thus, synchronization can be improved by a factor of K with the present invention and channel estimation is significantly improved since the channel parameters can be estimated every K chips during each transmitted symbol (f_{D}/K), for example, using a K-chip sliding correlator in which K-chips are constantly being correlated in marked contrast to estimating the parameters once per symbol for a short period of time during each burst of data as is currently prescribed in the IEEE Standards. Accordingly, the present invention overcomes the disadvantages of the prior art by providing correction substantially faster, where correction is increased essentially by a factor equal to the number of subchannels.

Other aspects and advantages of the present invention will become apparent from the following description taken in conjunction with the accompanying drawings, wherein like parts in each of the several figures are identified by the same reference characters.

### BRIEF DESCRIPTION OF THE DRAWINGS

FIG. 1 is a block diagram of a prior art OFDM/MIMO transmitter.

FIG. 2 is a block diagram of a prior art OFDM/MIMO receiver.

FIG. 3 is a block diagram of an OFDM/MIMO wireless communication system with a multipath communication channel.

FIG. 4 is a block diagram of an OFDM/MIMO transmitter according to the present invention.

FIG. 5 is a graphical representation of the orthogonal nature of an OFDM spectrum.

FIG. 6 illustrates subchannels in available bandwidth.

FIG. 7 illustrates repetition of chip code.

FIGS. 8(a), (b) and (c) illustrate symbols being transmitted, codeword duration and number of chips per codeword, respectively.

FIG. 9 illustrates a multipath channel in which the present invention can be used.

FIG. 10 is a block diagram of an OFDM/MIMO receiver according to the present invention.

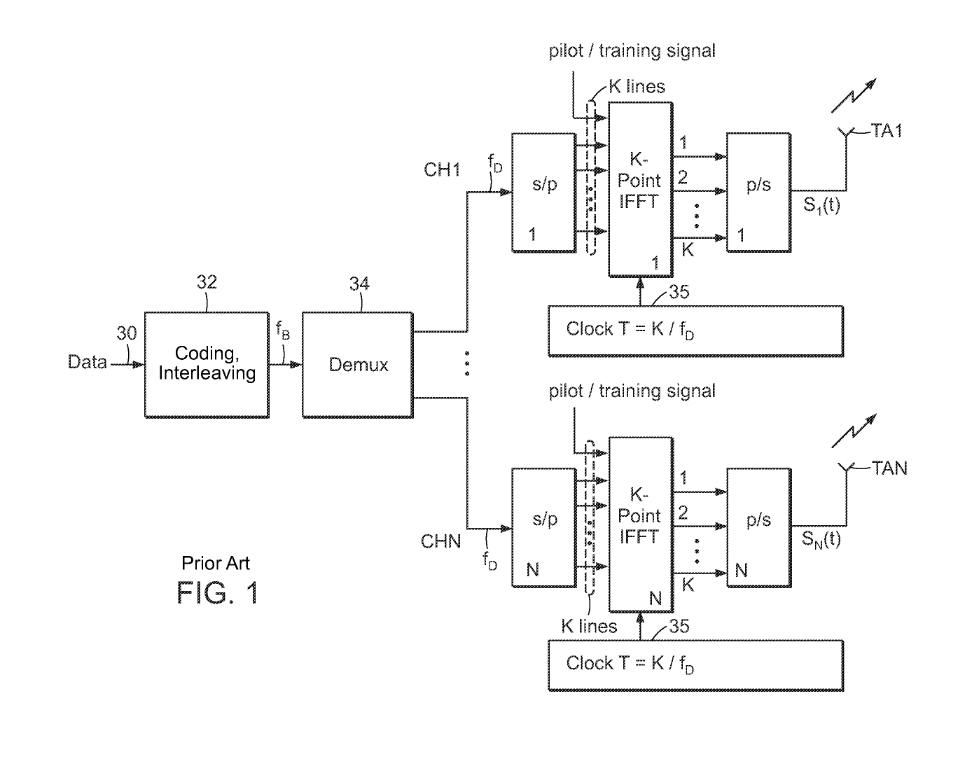

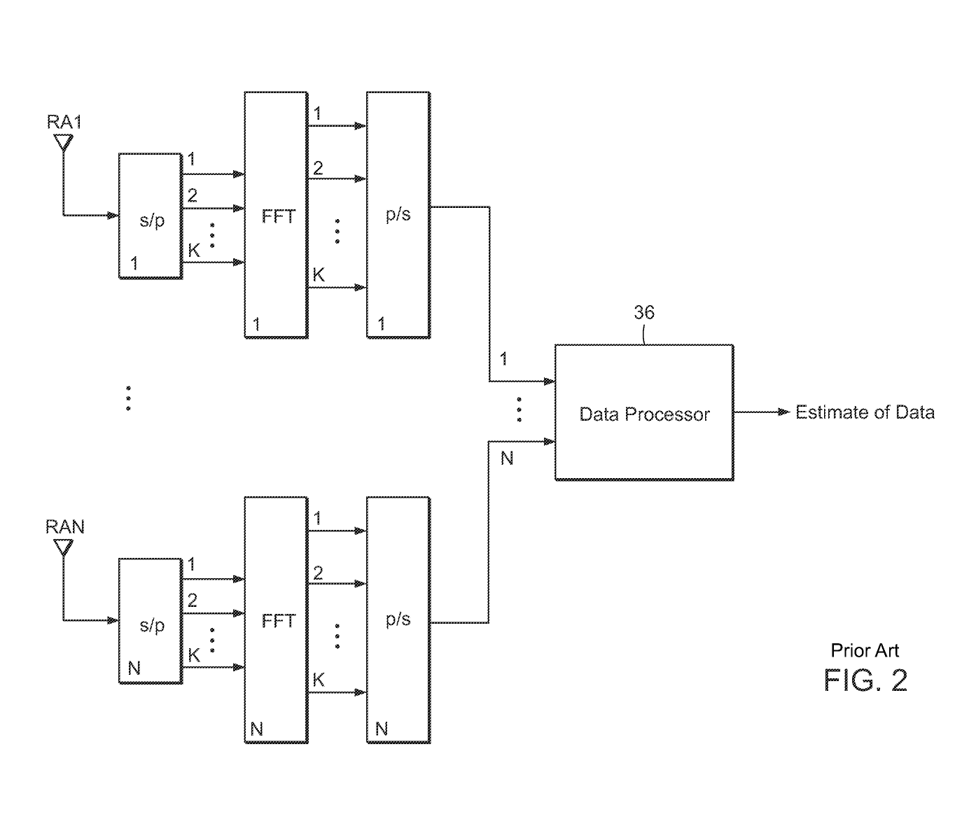

### DETAILED DESCRIPTION OF THE INVENTION

As used herein, “MIMO” means multiple antennas transmitting information from a transmitter into a wireless communications channel, and multiple antennas at a receiver receiving the information from the output of the wireless communications channel; “OFDM” means a multicarrier, orthogonal, modulation wireless communication spread spectrum technology using a frequency-division multiplexing scheme as a digital multi-carrier modulation method with a large number of closely-spaced orthogonal sub-carriers used to carry data which is divided into several parallel data streams or subchannels, one for each sub-carrier, each sub-carrier being modulated with a conventional modulation scheme, such as quadrature amplitude modulation, maintaining total data rates similar to conventional single-carrier modulation schemes in the same bandwidth, including, one or more, pilot signals to provide synchronization and tracking information; “IFFT” means an encoder using an Inverse Fourier Transform with a bandwidth B (where B=f_{D}) and K subchannels such that the bandwidth of each subchannel is B/K, the Inverse Fourier Transform process occurring every T=K/B sec, during which time a single input OFDM complex symbol is transformed into a wideband time waveform consisting of the sum of the K complex numbers forming the single OFDM symbol, where the time waveform f(t) is: f(t)=ΣF(wᵢ) e^{jwit}, at each time instant, t, during each time interval: 0 to T where i=1, 2, . . . , K and f(t) is the output of the IFFT. F(wᵢ) are the K input complex numbers forming an input OFDM symbol that is input to the IFFT in time T, each F(wᵢ) for i=1, 2, . . . K is fixed during each T sec interval, and the ensemble of F(wᵢ) during the time, T, is referred to as the OFDM symbol; “FFT” means a decoder which achieves the inverse of an IFFT; “demultiplexer” means a device which takes input data and, in a prescribed manner, outputs the data in more than one parallel data stream; “pilot signal” means a carrier, amplitude modulated by a “chip code” sent on one or more of the subchannels of the IFFT encoder output to form an OFDM signal; “chip code” means a binary sequence of bits chosen using a prescribed algorithm, for example Walsh functions, PN sequences, which can be extended to be orthogonal to other extended PN sequences, and other fixed length sequences; mₖ is the kth data input to an OFDM data symbol input to the IFFT encoder and correspondingly, at the output of the IFFT, it is transformed to sₖ(t) which is the signal transmitted at the kth subchannel frequency; “RAKE/Equalizer” means any technique employed in a receiver to combine multipath signals, the RAKE portion being typically used when multipath signals are non-overlapping, and typically not used when a system is restricted in use so that the multipath signals overlap, the Equalizer portion being used often when the multipath signals overlap and there is “flat fading;” “spatial data stream” means a data stream that is transmitted using a transmit antenna; “multipath signals” mean the signals, emanating from a transmit antenna, that travel in multiple directions simultaneously, depending on the shape of the antenna, such that multiple copies of the signals, delayed and attenuated with respect to one another, are received by a receiver antenna; and “multipath channel” means a path a signal takes from a transmit antenna to a receiving antenna, noting that multipath channels change with time as a result of changes in the environment.

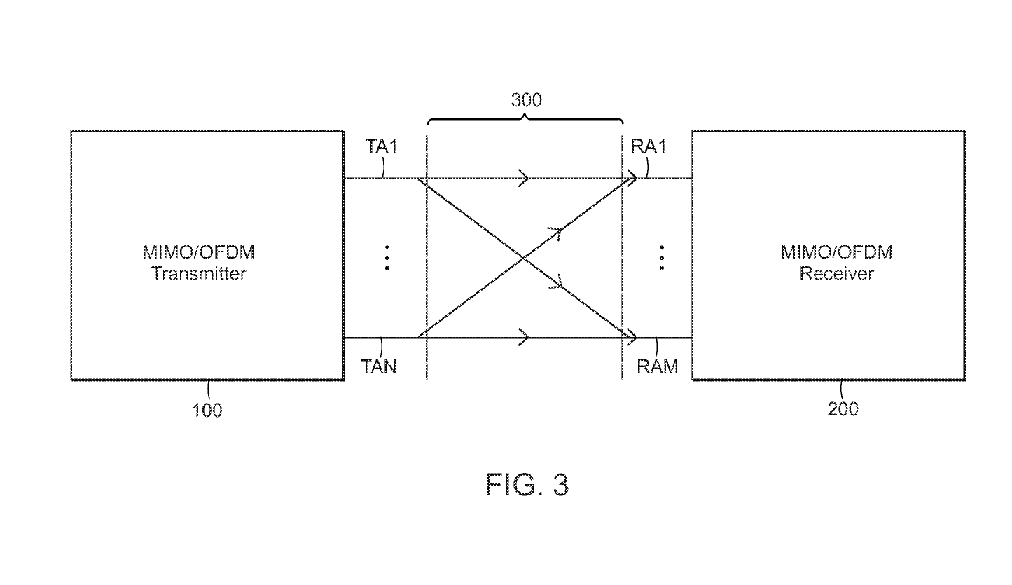

An OFDM wireless communication system according to the present invention includes, as shown in FIG. 3, at least one transmitter 100, at least one receiver 200 and a wireless multipath communication channel 300 between the transmitter and the receiver. Where the transmitter 100 is OFDM/MIMO it has multiple transmit antennas TA1 . . . TAN, and the receiver 200 has multiple receive antennas RA1, . . . , RAM, where M≧N. For purposes of simplicity the description herein assumes that M=N. FIG. 3 illustrates multipath transmissions in a simplistic manner. The present invention is described in connection with OFDM/MIMO wireless communication; however, it should be understood that the basic concept of the present invention (i.e. adding pilot signals to outputs of IFFT encoders as opposed to inputs of the IFFT encoders to form the OFDM signal) can be used in any OFDM (spread spectrum) communication system.

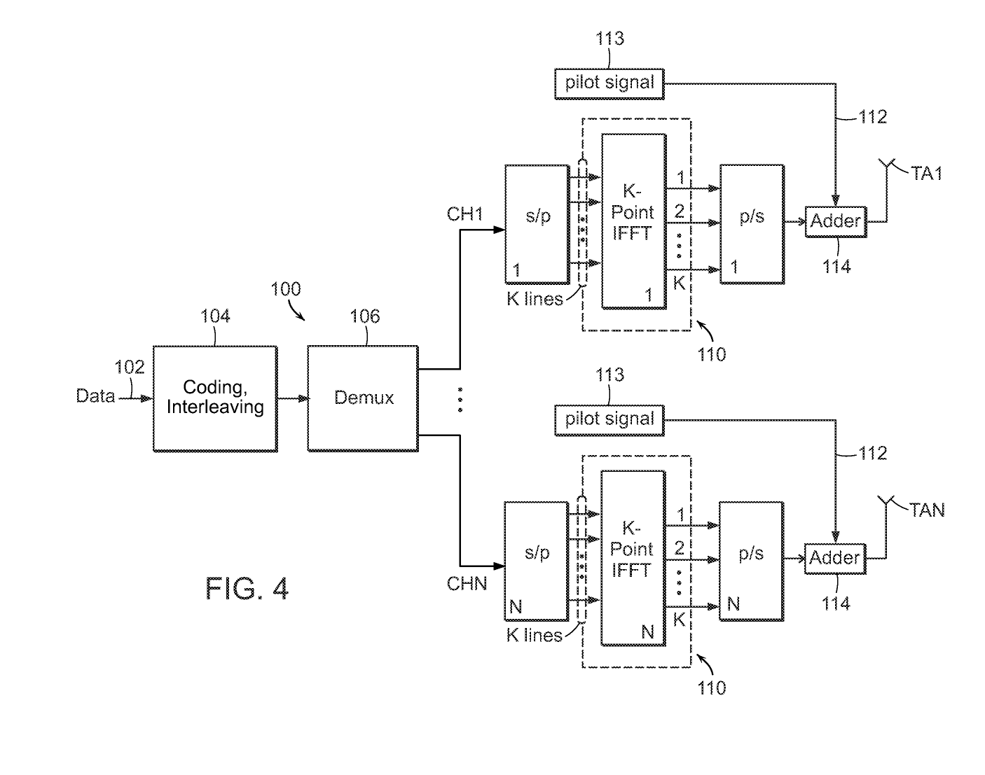

As shown in FIG. 4, in an OFDM/MIMO transmitter 100 according to the present invention, data 102 is coded for error control (FEC) and interleaved at 104, and the error control, interleaved signals are supplied to a MIMO demultiplexer 106 which has N spatial data signal outputs (CH1 . . . CHN), one spatial data signal for each transmitter antenna TA1 . . . TAN. FIG. 4 represents the conversion of input data to an OFDM symbol. Many other forms of input data processing can be used. For example, one such form would omit the coding/interleaving circuitry 104 and instead, in each channel, following the demultiplexer, insert a coding circuit, an interleaving circuit, and also a symbol mapping circuit to form a set of complex numbers often referred to as QAM symbols. These QAM symbols would then be input to the S/P converter, K complex words at a time, to form an OFDM symbol independent of the initial processing. Each spatial data stream is serial-to-parallel converted, each T sec, to form what is typically referred to as an OFDM symbol containing K complex numbers. Each OFDM symbol is inputted to the IFFT every T sec, by letting each of the K complex numbers be a separate input to the K inputs of the IFFT. These inputs represent the QAM modulation of the K multi-channels (data encoded subchannels) of the IFFT. The IFFT output is formed of K complex numbers, which change every T sec. During the time T each of the K outputs is sampled sequentially, once each T/K seconds, to produce a serial time waveform. This is done using a parallel-to-serial converter p/s. The IFFT transmitter produces an output spatial signal Sᵢ(t) where i=1, 2, . . . N. Each of these output spatial signals is added to a direct sequence spread spectrum (DSSS) pilot signal 112 (which is generated by a chip code source 113 having a different, usually orthogonal, code when compared to the other chip codes), at an adder 114, thereby forming N multi-channel spread spectrum (IFFT plus pilot signal) spatial combined signals. Each spatial combined signal is amplitude modulated (frequency translated) to the same radio frequency and input to a separate transmit antenna. The resulting IFFT spread—DS pilot signal is the OFDM signal.

The OFDM symbols consist of K complex numbers where some numbers may intentionally be set equal to zero. For example, in the IEEE Standard 802.11n, K=64, and the first 4 complex numbers and the last 4 complex numbers of the OFDM symbol are set to 0 to insure that the spectrum of the transmitted OFDM waveform does not interfere with other waveforms using nearby frequency bands. Accordingly, it will be appreciated that a transmitter in accordance with the present invention can have one or more complex numbers with value 0 placed as desired to avoid transmitting at one or more frequencies. Such frequencies could be in use by other users or could be frequencies subjected to significant fading. The particular complex numbers set to zero can be changed every T sec.

In summary each of the encoded signals, sᵢ(t), s₂(t), . . . , s_{N}(t), is a spatial signal since each signal is destined for a different transmit antenna, TA1, . . . , TAN. Each of the encoded signals is then added to a direct sequence spread spectrum pilot signal, pₖ(t), where n=1, 2, . . . , N, each pilot signal having codes c₁(t), . . . c_{N}(t), forming N spatial pilot signals. Each spatial pilot signal is amplitude modulated (frequency translated) to the same radio frequency f₀, and input to a separate transmitter antenna. Each of the pilot signals forms one set of substantially orthogonal pilot signals.

FIG. 4 represents a synchronous transmitting system, and there is a universal clock in the transmitter (not shown), which clocks the data, each IFFT, and each pilot signal synchronously. The IFFT and its clocking time, T, set the bandwidth of the system, which is typically specified by governmental regulations. The same clock clocks the data prior to the demultiplexer which is at a lower clock rate. Since each of the pilot signals is being used for synchronization, the same clock is used to determine the period of the spreading sequence employed, as well as the chip rate. The received signals differ from the transmitted signals due to multipath and are received at slightly different times due to the difference in path length to the receiver. However, the clock time T is chosen so that all signals and most of their multipath signals arrive at the receiver during the time interval T.

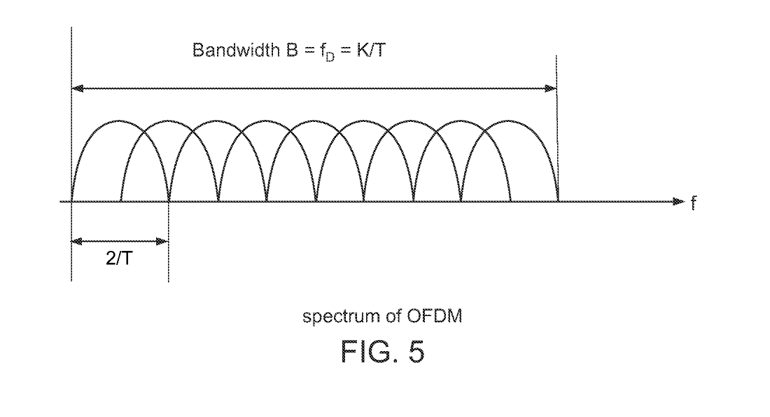

FIG. 5 shows the orthogonal nature of the OFDM spectrum. Note that the spectra of the adjacent subchannels overlap. It is well known that with a 50% overlap, as shown, the signals are still orthogonal. Thus, in OFDM, each of the subchannels has a bandwidth of 2/T=2f_{D}/K. The available bandwidth B is filled with K channels, where B=f_{D}, due to the 50% overlap shown in FIG. 5.

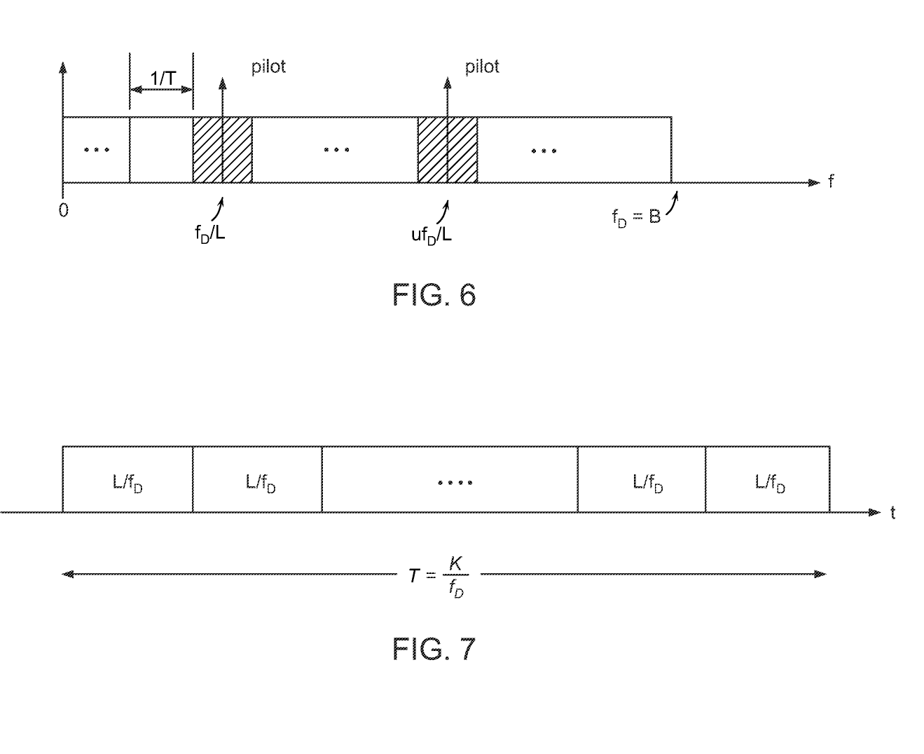

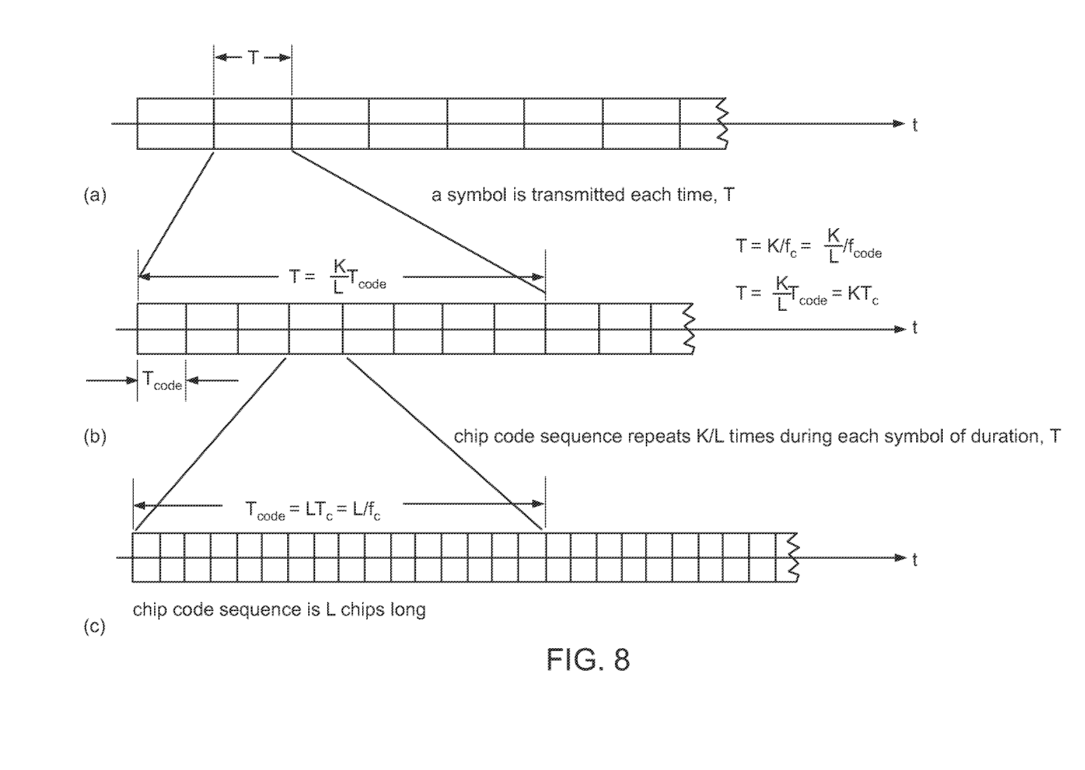

The chip code spreads the spectrum of the pilot signal. The spread spectrum spreading codes, used to amplitude modulate the carrier of the pilot signals, have a chip code rate which is K times greater than the IFFT symbol rate, 1/T. This type of amplitude modulation is called BPSK. The code rate is termed the chip rate to differentiate it from the data rate. The chip rate is f_{C}=f_{D}=B. Since there are N transmit antennas, N different pilot codes (signals) are used. Each of the N codes is periodic with the same periodicity. In one design, each code is orthogonal to the other codes. Since a code is periodic, it can be represented by a Fourier series, that is, by a series of amplitudes and phases, each located at a frequency which is harmonically related to the fundamental frequency, f_{C}. If there are L chips in the code (i.e. length of code), that is, the code sequence repeats after each set of L chips, the amplitudes are located at the frequencies: f_{T}(u)=uf_{C}/L=uB/L, where u is an integer 1, 2 . . . L. Thus, the pilot sequence has a spectrum with a tone every f_{C}/L as illustrated in FIG. 6. Each subchannel formed by the IFFT has a bandwidth 1/T=f_{D}/K. Since, f_{C}=f_{D} (the available bandwidth), there are K/L symbols/chip. The pilot signal is therefore seen to include overlapping frequency tones spaced f_{D}/L apart. If L=K, f_{T}=uf_{D}/K, a tone occurs at each of the OFDM subchannels. For this reason, L can be selected to be approximately K/8, so that a pilot tone occurs once in every 8 subchannels. FIG. 7 shows the chip code repeating every L chips with K/L such repetitions occurring during each symbol. FIG. 8(a) shows the symbols being transmitted from the IFFT as a function of time, that is at T second intervals. FIG. 8(b) shows the duration of a codeword, T_{code}, repeated K/L times during each symbol. Thus, in one design, K/L should be an integer. FIG. 8(c) shows that there are L chips/codeword and K chips/symbol.

The present invention involves the insertion of the direct sequence spread spectrum pilot signals, which have been amplitude modulated by the chip codes, c₁(t), . . . , c_{N}(t), each having a chip rate f_{C}, after the spatial signals have been encoded by the IFFT, that is, at the output of the OFDM system thus providing synchronization and channel estimation which is much more accurate in a given time, than in the prior art.

It should be noted, that a single transmitter pilot signal with a single chip code, can be used to replace the multiple pilot signals, each with its own code as used in current OFDM/MIMO systems, such as the systems described in IEEE Standard 802.11n. Such pilot systems are commonly employed in Direct Sequence CDMA systems. One advantage, in addition to a reduction in complexity, is that the number of orthogonal codes is limited and equal to L. Thus, using a single pilot signal with a single code would permit a multiple access system to be employed where the number of simultaneous users would be limited to L. If “almost” orthogonal codes are used, the number of simultaneous users can be increased. This process is referred to as “multiple access”. In a MIMO receiver, N pilot signal receivers must still be employed, since the transmitted pilot when received at each receiver has a different phase. With such a substitution, the single transmitted signal should be transmitted from only a single antenna of the N transmit antennas. Thus, the path taken by a single pilot signal transmitted, for example, from antenna TA-M and received by receive antenna RA-J, will have different multipath than the signal transmitted from TA-J and received by RA-J.

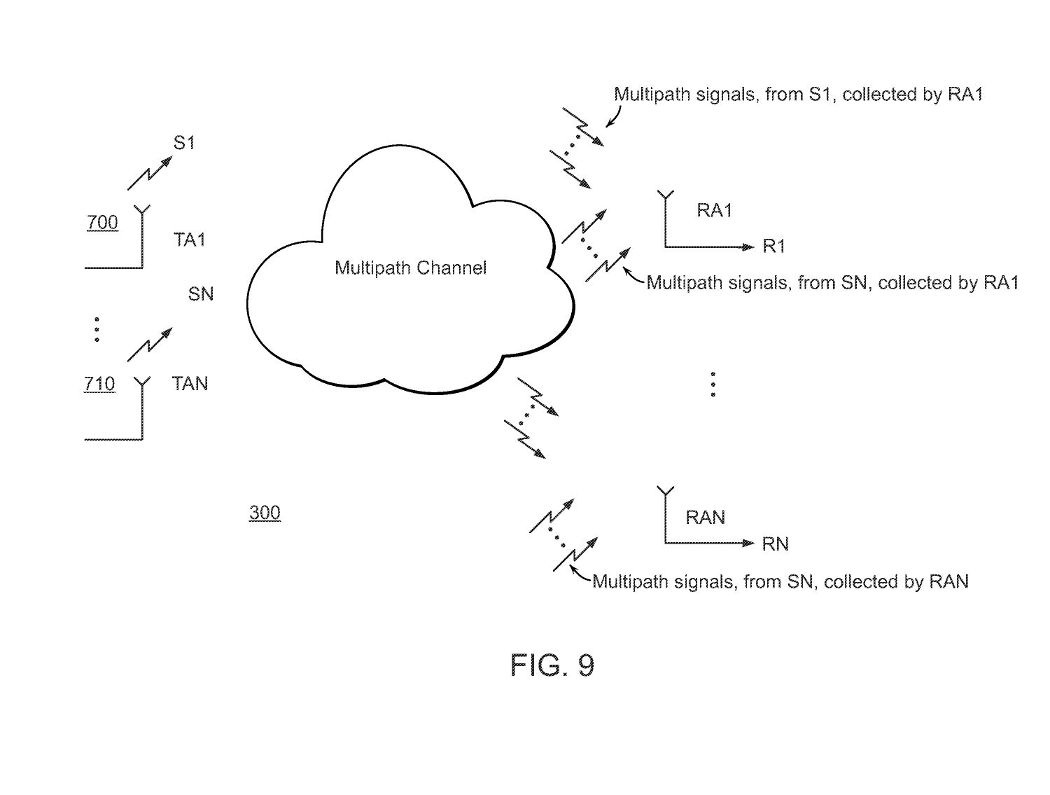

The multipath channel 300 is explained with reference to FIG. 9. The N transmitted signals each travel, for the most part, beyond line of sight. That is, the transmitter does not see the intended receiver. Also, each transmit antenna sends the same transmitted signal as multiple rays, along different paths, depending on the construction of the antenna. These signals are called multipath signals. The multipath signals, by taking different routes, are each partially absorbed and reflected from the surfaces they meet. Such surfaces can include buildings, cars, people, leaves, etc. As a result, some of the rays may be blocked and never reach the intended receiver. Others are delayed and attenuated relative to each other. Typically, relative delays in urban areas, buildings, etc, do not exceed 1 μs (which corresponds to a differential distance of 300 meters). Also, typically, the longer the relative delay, the more the transmitted signal is attenuated and therefore loses importance relative to a signal received with significantly greater energy.

FIG. 9 illustrates the multipath signals being received by receive antennas RA1 and RAN. Each receive antenna can collect signals from all, or some, of the transmit antennas. All of the received signals entering the antenna are added when the electromagnetic energy is converted to a voltage. The multipath signals from a particular transmit antenna often overlap one another in time when received, and these signals may cancel one another after passing through the FFT receiver. This effect is referred to as flat multipath fading. It is not unusual to find a 20 dB fade extending over a bandwidth of several MHz. The received signal at receive antenna RA1 consists of the sum of multiple waveforms from each antenna. There are N antennas, each transmitting K subcarrier signals plus all of the multipath signals. Thus, R₁ is:

R₁=h₁₁s₁h₁₂s₂+ 1.

where hᵢⱼ represents the channel attenuation and delay due to the path taken by each of the transmitted signals. In this case, i means receive antenna i, and j means transmit antenna j.

If multipath occurs:

Rᵢ=ΣΣ(hᵢⱼₖ×sⱼₖ) 2.

where i is the particular receive antenna, j is the particular transmitter signal, and k is the kₜₕ multipath copy of the jth transmitter signal. Equation 2 mathematically describes the addition of all signals occurring at the antenna.

If the relative delays of the multipath signals are comparable, that is small compared to the symbol duration, and/or, if a RAKE (equalizer) is employed, the values of h can be considered to vary slightly during a symbol, and an equivalent hᵢⱼ can be employed to replace hᵢⱼₖ. The result simplifies to Eq 1:

R₁=h₁₁s₁+h₁₂s₂+

R₂=h₂₁s₁+h₂₂s₂+ 3.

Or, in matrix notation:

R=HS 4.

In each receiver R is measured. If the value of H is known, S could be calculated. However, the values of R that were measured contain noise, and the values of H change with time. Thus, to estimate the values of S, R is measured, H is estimated and then the received signals: Sₑₛₜ: s₁, s₂, . . . , are estimated by solving the simultaneous equations, given by Eq 4. In matrix form this can be written as:

Sₑₛₜ=H⁻¹R/H⁻¹H 5.

H, is a slowly varying function of time, and is estimated on a symbol-to-symbol basis; that is, H is considered to be a random variable, rather than a continually varying random process. There are numerous techniques available to estimate H, such as Least Mean Square Estimation and Maximum Likelihood Estimation. No particular technique is described herein for purposes of simplicity; however, whatever technique is used, the present invention produces a new, reliable estimate of H during each symbol, thereby enabling the receiver to properly estimate the transmitted data. The prior art requires many symbols to estimate H. Alternately, the prior art requires a very slowly varying channel. In the present invention, the chip rate is greater than the symbol rate; and, therefore, the channel transfer function H can be accurately estimated during a single symbol. This is very important for rapidly varying channels, such as those encountered during the time that a user is mobile. To achieve this accurate estimation capability, in accordance with the present invention, the pilot signal is added to the OFDM signal after the IFFT encoding of the input data.

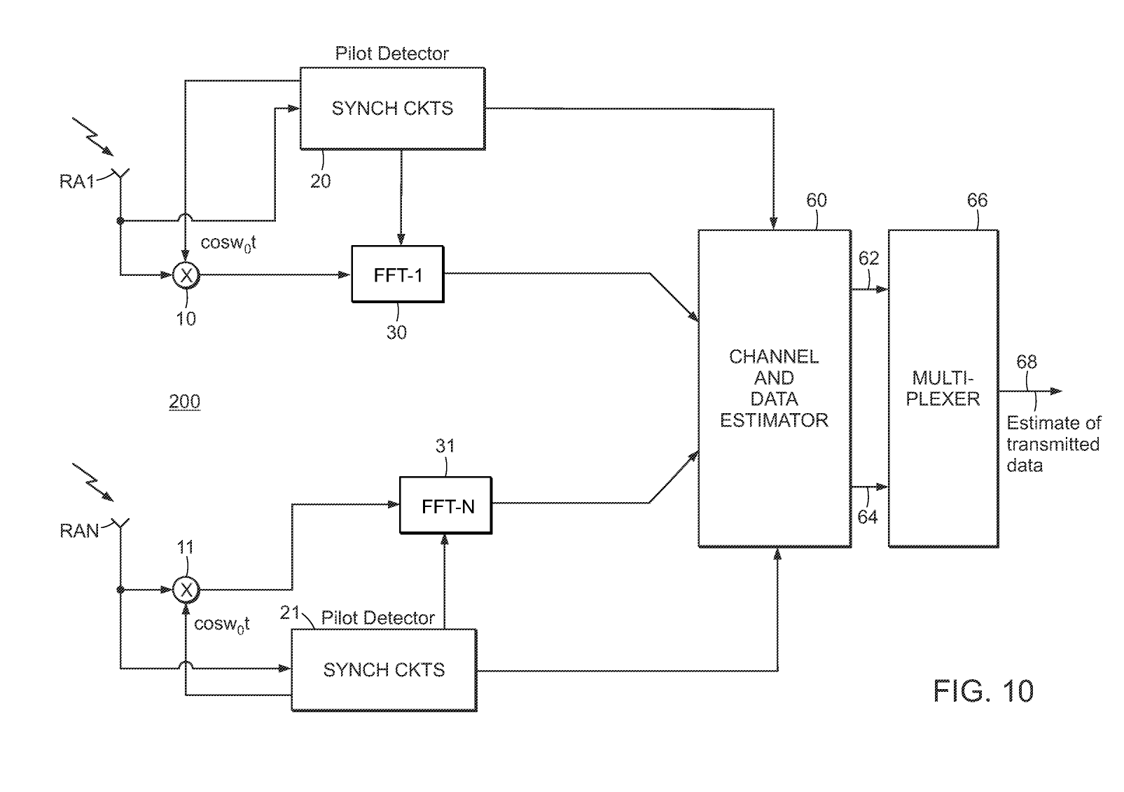

FIG. 10 illustrates a receiver 200 for an OFDM/MIMO system according to the present invention to undo the operations performed in the transmitter in order to estimate the transmitted data. In the receiver, the incoming signals are first received by the N, receive antennas RA1 . . . RAN, and the sum of these signals is then down-converted, 10, 11. The pilot detector synch circuits, 20,21, contain locally generated oscillators which synchronize to the incoming signals and are employed to detect the transmitted direct sequence spread spectrum pilot signals and synchronize to the carrier frequency, fₐ. The pilot detectors also synchronize the local receiver oscillators to the incoming direct sequence codes (c₁, . . . , C_{N}) replicas of which are resident in the receiver. Essentially, each of the N sub-receiver circuits separates the combination signal at each receive antenna into a received pilot signal and received OFDM encoded data signals. The received OFDM encoded data signals are supplied to FFTs 30,31. The pilot detectors 20, 21 serve to instruct the sampling circuits 10,11 preceding the FFTs when to sample, so that the K input samples can be obtained during each time T and inputted to the FTTs. The pilot signal also controls when the FFT should perform its transforming process. A channel and data estimator circuit 60 receives inputs from FFTs 30,31 and supplies estimated data 62,64 from each stream, 1 to N, to a multiplexer 66 which provides a single stream of data 68. The channel and data estimator includes combiner circuitry for combining signals received at each antenna. Each of these operations is synchronized by the pilot clock.

If the receiver attempts the initial synchronization of a pilot code sequence contained in a transmitted pilot signal and it is not sufficient to synchronize to the received code, the timing needed for each of the FFTs, which occurs after K/L code repetitions, can be determined. To achieve synchronization, a variable clock (not shown) in each pilot detector is used to establish the timing of each of the pilot signal generators in the receiver. The pilot detectors in the receiver are readily synchronized to the pilot code signals sent by the transmitter, and the correct code sequence is found. The determination of which code should enable the FFT is the next step in the synchronization process. If the pilot detector timing that was selected is incorrect, the FFT will not fire at the correct time, and the signals from the FFTs, after further processing, may produce a data output with a high error rate. If this occurs, the clocking time can be slipped by one code word in the code sequence, until the proper performance is attained. Thus, K/L symbols may be tested to acquire the correct synchronization. Further fine tuning can be achieved by periodically slipping one chip back and forth and testing the system error rate in actual operation. The fine synchronization process continues throughout system operation. If the system falls “out of synch” the coarse synchronization process will start anew.

To explain the procedure in greater detail, note that the chip codes employed as pilot signals are known by the receiver. Eq 3 can therefore be readily solved for the channel parameters H. To illustrate this process, assume that there are only two transmit and two receive antennas. Then, the transmitted signals are,

s₁(t)=m₁(t)+p₁(t), 6.

and

s₂(t)=m₂(t)+p₂(t), 7.

where m₁ and m₂ contain the data information and p₁ and p₂ are the chip modulated pilots.

In one embodiment, the number of chips in the code is equal to L=K/8, which is the number of subchannels used by the chip code (The number 8=2³. Since the total number of subchannels used by the OFDM encoder is usually a multiple of 2, using 8 yields an integer number of subchannels used by the coder.) For example, if the total number of subchannels used by the encoder is K=256 (=2⁸), the number of chips in the code, before the code starts to repeat, is L=256/8=32 (=2⁵). There are then 32 subchannels used by the chip code. The symbol transmission time is T_{S}=K/f_{C}=K/f_{D}. During the symbol time, the code in the pilot signal, which repeats every T_{code}=L/f_{C}, is repeated K/L=8 times. Thus, in one design, the entire chip code is repeated 8 times during a symbol, and the chip code enables an accurate estimation of the channel during the symbol time.

At the receiver FFT outputs, let us assume, for the purpose of illustration, that the chip codes used are the Walsh Functions, and that L=8. Let c₁=W₁=11001100. and c₂=W₂=10011001. Then, from Eqs 6 and 7:

R₁=h₁₁m₁+h₁₂m₂+h₁₁W₁+h₁₂W₂ 8.

and

R₂=h₂₁m₁+h₂₂m₂+h₂₁W₁+h₂₂W₂ 9.

The pilot detector 20 multiplies received signal, R₁, by the stored codeword, W₁ and averages over the 8 Walsh function chips. The average value of W₁×W₂=0. In one design, in order to minimize interference, no data is transmitted in the subchannels occupied by the pilot code. Since R₁ is known, and M₁ and M₂ are each equal to zero in these subchannels:

h₁₁=avge(W₁×R₁) 10.

Similarly,

h₁₂=avge(W₂×R₂) 11.

Performing the same operations on R₂, yields:

h₂₁=avge(W₁×R₂) 12.

and

h₂₂=avge(W₂×R₂) 13.

The averaging can occur not just over a single codeword, but over two or more pilot codewords in the symbol. Therefore, in this example, let us assume that:

W₁= . . . 1100110011001100 . . . ,

and that R₁ is sampled once, each symbol (that is every T sec). Then, from time T₁ to T₈:

avge((11001100)×R₁) 14.

From T₂ to T_{g}, that is starting one codeword later, the next average can be performed:

avge((10011001)×R₁) 15.

Thus, the value of h₁₁ is updated at the chip rate. The other values of h are similarly determined and updated. These values of H are used in the data estimator 60, to determine the estimate of the transmitted data. Using the above procedure, the value of H can be updated after every chip.

An alternative, simpler, approach can be used where the average is taken after each pilot codeword. Using this approach, with K/L=8, the transfer function H is estimated 8 times per symbol.

Accordingly, update of the channel parameters, H is “continual” in accordance with the present invention.

Equations 10, 11, 12, and 13 require that the average value of the pilot sequences, when multiplied by the received data streams, is zero. Thus, in Eq 8, it is assumed that

avge(W₁×m₁)=0

and

avge(W₁×m₂)=0 16.

The above is a valid assumption since m₁ and m₂ are constant during the duration of the symbol since they are the outputs of the FFT.

In the synchronization procedure described, pilot detectors 20, 21 synchronize independently to their input signals derived from RA1, RAN. Thus, the pilot detectors and their respective FFTs are synchronized, even though the output of each FFT may not occur at exactly the same time, since the pilot signals from each transmit antenna arrive at the receive antennas at slightly different times.

From the above, it will be appreciated that the pilot signals can each have a different chip code and the same code length and the chip rate divided by the code length can, thus, be greater than or equal to the subchannel bandwidth of the IFFT encoder.

The signals from FFT-1, . . . , FFT-N are received in the data estimator 60 which performs several tasks, the primary of which is space diversity combining. These terms are slightly offset in time from one another. In addition, the channel coefficients also arrive, synchronized to their specific FFT, but slightly offset in time from one another. The data estimator clocks all of the arriving signals using a data estimator clock (not shown) in order to obtain data samples to determine the transmitted data. Samples of the same signal with different channel coefficients are added and represent “space diversity” feature of a MIMO system. The timing of the data estimator clock can be adjusted in an attempt to provide the best estimate of the data to the circuits following the data estimator.

Accordingly, an OFDM transmitter for use in a wireless communication system utilizing the concept of adding pilot signals to the output of an OFDM encoder, as shown in FIG. 4, includes an IFFT encoder (K-IFFT) having an input (from SIP) and the IFFT encoder produces an output signal spread over a bandwidth formed of subchannels. A pilot signal source 113 generates a direct sequence spread spectrum pilot signal which is supplied to an adder 114. Pilot signals are added to the IFFT encoded output signals to produce a combination IFFT spread spectrum signal carrying data and the pilot signal spread over the same bandwidth. The combined signals are supplied to a transmit antenna for transmitting of the combination signal. A second or other IFFT encoder can be included in the transmitter receiving a similar data signal input and an output containing subchannels where a number of the subchannels carry data and a number of the subchannels do not carry data, the other IFFT encoder producing an output spread over the same bandwidth as the first encoder. In the manner described above, another direct sequence spectrum pilot signal is generated and added to the output of the other IFFT encoder.

As previously noted, an OFDM receiver for use in a wireless communication system to receive an OFDM transmission containing a combination signal formed of an IFFT encoded signal carrying data that is added to a pilot signal includes an antenna for receiving the combination signal, a pilot signal detector receiving the pilot signal from the antenna for detecting the pilot signal for synchronization and a signal channel estimation and data detector receiving the IFFT encoded data signal and, aided by the detected pilot signal, detects the data to undo the IFFT encoding. The OFDM receiver includes a synchronization system containing N receiver-based pilot detectors each associated with a different FFT with each pilot detector synchronizing its frequency and phase to the incoming pilot signal's frequency and phase, the frequency and phase adjustment being different for each received pilot signal. The receiver pilot detectors provide timing by adjusting the clock rate of its respective FFT to determine the time waveform output of the FFT. The FFT outputs are tested; and, if the synchronization point selected is false, the spectrum of the pilot signal will occupy more than L frequency subchannels permitting detection of false synchronization and the clock timing is adjusted to obtain correct synchronism and the appropriate sampling for testing time.

As discussed above, in accordance with the present invention, pilot signals are added to OFDM encoded signals at a transmitter providing enhanced synchronization and channel estimation. The pilot signals can have different chip codes with each chip code having the same code length, and the chip rate divided by the code length greater than or equal to the subchannel bandwidth of the encoder. The chip codes have a chip rate substantially equal to the available bandwidth. A receiver having antennas receiving the combined signals formed of the encoded signals and the added pilot signals includes a signal detector for estimating the data received at each antenna, a combiner for combining data received and a multiplexer to multiplex the data received from each antenna into a single data stream. The transmitter can include first and second IFFT encoders and first and second sources generating first and second direct sequence spread spectrum pilot signals to produce two combination spread spectrum signals carrying data and spread spectrum pilot signals spread over the bandwidth. An OFDM receiver can include a pilot signal detector for detecting the pilot signal for synchronization and signal channel estimation and a data detector receiving encoded data signals and, aided by the pilot signal, detecting the data to undo the encoding. An OFDM receiver method includes the steps of providing a plurality of FFT circuits, and a plurality of pilot detectors at an OFDM receiver, with each of the pilot detectors associated with a different FFT circuit, synchronizing the frequency and phase of each pilot detector to the frequency and phase of the pilot signal with the frequency and phase being different for each received pilot signal, each pilot detector providing timing by adjusting the clock rate of its respective FFT to determine a time waveform output of the FFT, testing the FFT outputs to determine if the spectrum of the pilot signal will occupy more frequency subchannels then the length of the pilot code to determine any false synchronization, and adjusting the clock timing, if a false synchronization is determined, to obtain correct synchronism and the appropriate sampling time for the FFT. The receiver method can include synchronizing of a plurality of pilot detectors and FFTs so that each of the FFTs is sampled at the correct time, adding the synchronized samples from each FFT and adjusting the delay of each relative to the others in RAKE/Equalizer circuitry to provide spatial and time diversity and multiplexing signals from the FFTs to form a serial data stream.

The code modulated pilot signals are used for frequency synchronization and can also be employed to estimate the channel transfer function characteristics. As the synchronization and channel estimation are done at the code's chip rate, not at the symbol rate, the synchronization and estimation is much more accurate, noting that the number of chips/symbol can be a large number, such as 256, as shown in the above example.

The concept of the present invention of adding pilot signals to the output of an IFFT encoder (i.e. after encoding data/symbols) can readily be implemented in a transmitter and receiver of an OFDM system.

Inasmuch as the present invention is subject to many variations, modifications and changes in detail, it is intended that all subject matter discussed above or shown in the accompanying drawings be interpreted as illustrative only and not be taken in a limiting sense.

What is claimed is:

1. An OFDM/MIMO transmitter for use in a wireless communication system, said transmitter comprising
means for coding and interleaving data signals;
means for demultiplexing the coded and interleaved data signals to produce demultiplexed spatial signals;
an IFFT encoder arrangement receiving said demultiplexed spatial signals and generating a plurality of IFFT transformed, and thereby spread, signals;
a source generating pilot signals;
means adding said pilot signals to said IFFT transformed signals to produce transmit signals formed of said pilot signals added to said IFFT transformed signals; and
a plurality of antennas for transmitting said transmit signals, each of said antennas transmitting one of said transmit signals.

2. An OFDM/MIMO transmitter as recited in claim 1 wherein said pilot signals each have a different chip code and each have the same code length and the chip rate divided by the code length is greater than or equal to the subchannel bandwidth of the IFFT encoder.

3. An OFDM/MIMO transmitter as recited in claim 1 wherein said pilot signals are spread spectrum chip codes for use in determining synchronization and channel estimation

4. An OFDM/MIMO transmitter as recited in claim 3 wherein said IFFT transformed signals represent symbols transmitted at a symbol rate and said chip codes have a chip rate substantially equal to the available bandwidth.

5. An OFDM/MIMO wireless communication system comprising
an OFDM/MIMO transmitter including circuitry for coding and interleaving data signals, a demultiplexer demultiplexing the coded and interleaved data signals to form spatial signals, IFFT transformers to transform and spread each of the spatial signals, adders receiving each of the IFFT transformed spatial signals along with one of a set of substantially orthogonal pilot signals and an antenna to receive each of the OFDM encoded signals with the added pilot signals and to transmit the IFFT transformed signals and the added pilot signals over a fading multipath channel; and
an OFDM/MIMO receiver including antennas receiving the transmitted OFDM encoded signals with the added pilot signals, pilot detector means for detecting the pilot signals and synchronizing and determining channel parameters, a signal detector for estimating the data received at each antenna, a combiner for combining data received at each antenna and a multiplexer to multiplex the data received from each transmit antenna into a single data stream.

6. An OFDM transmitter for use in a wireless communication system comprising
an IFFT encoder having an input containing a data signal, at a symbol rate, and an output, said IFFT encoder producing an output waveform at said output spread over a bandwidth;
a source generating a direct sequence spread spectrum pilot signal spread over said bandwidth;
an adder, coupled with said output of said IFFT encoder and with said source generating said direct sequence spread spectrum pilot signal, for adding said direct sequence spread spectrum pilot signal to said IFFT output waveform to produce a combination IFFT spread spectrum signal carrying data and said pilot signal spread over the same bandwidth; and
a transmit antenna for transmitting said combination signal.

7. An OFDM transmitter as recited in claim 6 wherein the said IFFT encoder produces an OFDM symbol formed of complex numbers of which some are set at zero and the remaining complex numbers contain data.

8. An OFDM transmitter as recited in claim 7 wherein the complex numbers set at zero can be changed for each OFDM symbol.

9. An OFDM transmitter as recited in claim 6 and further comprising
at least one other IFFT encoder having an input receiving a data signal and an output containing subchannels, a number of the subchannels carrying data and a number of the subchannels not carrying data, said other IFFT encoder producing an output spread over said bandwidth;
a source generating another direct sequence spread spectrum pilot signal spread over said bandwidth;
an adder, coupled with said output of said other IFFT encoder and with said source generating said another direct sequence spread spectrum pilot signal, for adding said another direct sequence spread spectrum pilot signal to said other IFFT output to produce another combination spread spectrum signal carrying data and said another spread spectrum pilot signal spread over said bandwidth; and
another transmit antenna for transmitting another combination signal.

10. An OFDM transmitter as recited in claim 9 wherein said spread spectrum pilot signals have a code length which is equal to the number of subchannels not carrying data.

11. An OFDM receiver for use in a wireless communication system to receive an OFDM transmission containing a combination spread spectrum signal formed of an IFFT encoded signal carrying data added to a spread spectrum pilot signal, said OFDM receiver comprising an antenna for receiving the combination signal;
a pilot signal detector receiving the pilot signal from the antenna for detecting the pilot signal for synchronization and signal channel estimation; and
a data detector receiving the IFFT encoder data signal and aided by the pilot signal for detecting the data to undo the IFFT encoding.

12. An OFDM wireless communication method comprising the steps of
encoding data into an OFDM symbol and thereby spreading the OFDM symbol over a bandwidth to be transmitted to produce an IFFT spread spectrum encoded data signal;
adding a spread spectrum pilot signal to said encoded OFDM symbol; and
transmitting simultaneously, the IFFT encoded OFDM symbol and the added pilot signal as a combined signal from a transmit antenna.

13. An OFDM wireless communication method as recited in claim 12 and further comprising the steps of
receiving the combined spread spectrum signal at a receive antenna;
separating the combined signal into a received pilot signal and a received IFFT encoded data signal;
detecting the received pilot signals for synchronization and signal channel estimation; and
detecting the IFFT encoded data signal with the aid of the detected pilot signal to undo the encoding, thereby recovering the data.

14. An OFDM wireless communication method as recited in claim 13 and further comprising the steps of
receiving the combined signal at each of a plurality of receive antennas;
detecting and combining the data signals from each receive antenna; and
multiplexing the resulting data signals to obtain a single stream of data which is an estimate of the transmitted data.

15. An OFDM receiver method for use in a wireless communication system to receive an OFDM transmission containing a signal formed of an IFFT encoded signal added to a pilot signal, said OFDM receiver method comprising the steps of
providing a plurality of antenna systems to detect the OFDM transmission,
providing FFT circuits and a plurality of pilot detectors at the output of each antenna system, each of the pilot detectors being associated with a different FFT circuit;
synchronizing the frequency and phase of each pilot detector to the frequency and phase of the pilot signal, the frequency and phase being different for each received pilot signal;
each pilot detector providing timing by adjusting the clock rate of its respective FFT to determine a time waveform output of the FFT;
testing the FFT outputs to determine if the spectrum of the pilot signal will occupy more frequency subchannels than the length of the pilot codes to determine any false synchronization; and
adjusting the clock timing, if a false synchronization is determined, to obtain correct synchronism and the appropriate sampling time for the FFT.

16. An OFDM receiver method for use in a wireless communication system to receive an OFDM transmission containing a combination signal formed of an IFFT encoded signal added to one or more orthogonal pilot signals, said OFDM receiver method comprising the steps of
synchronizing a plurality of pilot detectors and FFTs in a receiver so that each of the FFTs is sampled at the correct time;
adding the synchronized samples from each FFT and adjusting the delay of each relative to the others in RAKE/Equalizer circuitry to maximize the summation thereby providing spatial and time diversity; and
multiplexing signals from the FFTs to form a serial data stream.

17. An OFDM/MIMO transmitter for use in a wireless communication system, said transmitter comprising
means for demultiplexing input data signals to be transmitted to produce demultiplexed spatial signal streams;
means for FEC coding and interleaving each of the said spatial signal streams;
means for mapping each of the FEC coded and interleaved spatial signal streams into a complex stream of numbers forming OFDM symbols;
an IFFT encoder arrangement receiving said OFDM symbols and generating a plurality of IFFT transformed signals;
a source generating pilot signals;
means adding said pilot signals to said IFFT transformed signals to produce transmit signals formed of said pilot signals added to said IFFT transformed signals; and
a plurality of antennas for transmitting said transmit signals, each of said antennas transmitting one of said transmit signals.

18. An OFDM/MIMO transmitter as recited in claim 17 wherein said pilot signals each have a different chip code and each have the same code length and the chip rate divided by the code length is greater than or equal to the subchannel bandwidth of the IFFT encoder.

19. An OFDM/MIMO transmitter as recited in claim 17 wherein said pilot signals are spread spectrum chip codes for use in determining synchronization and channel estimation.

20. An OFDM/MIMO wireless communication system comprising
an OFDM/MIMO transmitter including a demultiplexer demultiplexing input data signals to form spatial signal streams, circuitry for coding and interleaving each spatial signal stream and mapping each coded and interleaved spatial signal stream into a complex symbol stream to form an OFDM symbol, IFFT transformers to transform and spread each of the OFDM symbols, adders receiving each of the IFFT transformed OFDM symbols along with one of a set of substantially orthogonal pilot signals and an antenna receiving each of the OFDM symbols with the added pilot signals and to transmit the IFFT transformed OFDM symbols and the added pilot signals over a fading multipath channel; and
an OFDM/MIMO receiver including antennas receiving the transmitted OFDM symbols with the added pilot signals, pilot detector means for detecting the pilot signals and synchronizing local oscillators to the pilot signals, a channel and signal detector for estimating the data received at each antenna, a combiner for combining data received at each antenna and a multiplexer to multiplex the data received from each transmit antenna into a single data stream.
